(19) United States
(12) Patent Application Publication
(10) Pub. No.: US 2008/0041674 A1
(43) Pub. Date: Feb. 21, 2008

(54) Carbon-carbon stator insert for aircraft brakes

(75) Inventors: Terence B. Walker, South Bend, IN (US); Laurie A. Booker, South Bend, IN (US); Akshay Waghray, Granger, IN (US)

Correspondence Address: HONEYWELL INTERNATIONAL INC.;Law Department AB 2, P.O. Box 2245, Morristown, NJ, 07962-9806, US

(73) Assignee: HONEYWELL INTERNATIONAL INC.

(21) Appl. No.: 11/505,804

(22) Filed: Aug. 18, 2006

(51) Int. Cl. F16D 65/12

(52) U.S. Cl. 188/218 XL

(57) ABSTRACT

The present invention relates to annular drive inserts which are placed within an annular opening within the brake disk. Preferably the annular drive inserts comprise carbon-carbon composite which has been treated with antioxidant. In a highly preferred embodiment the treatment is accomplished by vacuum impregnation. The antioxidant generally comprises a standard phosphoric acid based solution. This invention solves a need in the art for annular drive inserts that have improved resistance to oxidation and strength.

### FIELD OF THE INVENTION

The field of the present invention generally pertains to carbon friction members for brakes. More particularly, this invention pertains to carbon-carbon composite annular drive inserts which are placed within an annular opening within the brake disk.

### BACKGROUND OF THE INVENTION

In brake assemblies which employ brake discs splined to the wheel and axle, of an aircraft for example, it is important to provide specially constructed drive means to reinforce the peripheral slots in the discs, and relieve the severe stressing that otherwise would rapidly deteriorate the periphery of the discs. Carbon-carbon composite brake discs have improved braking and heat sink characteristics and have become more widely utilized. However, it is important to provide reinforcing inserts at the peripheral slots of the discs because the carbon-carbon composite brake discs have less strength than steel. The problem with the use of metallic inserts is that the inserts are heavy and may negatively impact sliding of the stators on splines of the torque tube.

One solution to the above problems has been provided by a drive insert in combination with a brake disc. The disc is generally annular with a central opening, and an edge surface having recesses that extend radially into the disc. The drive insert has a cylindrical body with an opening which extends into the body. The insert opening terminates at an axially extending surface located between the center of the body and an outer surface of the body, and end flanges extending from the body, each of the end flanges extending radially outwardly from the outer surface of the body to provide axial positioning of the drive insert relative to the disc, the body of the annular drive insert located rotatably within said annular recess and retained axially in place by said flanges which may engage opposite side surfaces of the disc.

However, there are two related problems that generally relate to the carbon-carbon disk. The first is excessive slot wear, which causes disks to have to be scrapped prior to refurbishment. A second problem is oxidation of stator lugs due to contamination with potassium acetate runway deicers and high operating temperatures.

Accordingly, there is a need in the art for removable carbon-carbon composite inserts with better oxidation resistance and improved strength.

### SUMMARY OF THE INVENTION

The present invention is directed to a removable insert made from a higher strength carbon-carbon composite. The carbon-carbon composite is treated with antioxidant solution. Preferably, the carbon-carbon composite will have been vacuum pressure impregnated with antioxidant solution. With this approach the lug strength and the oxidation resistance can be simultaneously improved. The removable insert allows for replacement if excess wear occurs.

### BRIEF DESCRIPTION OF THE DRAWINGS

FIG. 1 shows an aircraft carbon-carbon composite brake disc with annular drive inserts in accordance with the present invention.

FIG. 2 is an enlarged view of the circled section of FIG. 1.

### DETAILED DESCRIPTION OF THE INVENTION

The present invention is directed to a removable insert for a disc brake made from a higher strength carbon-carbon composite. The carbon-carbon composite insert is treated with antioxidant solution. Preferably, the carbon-carbon composite is vacuum pressure impregnated with antioxidant solution. With this approach the lug strength and the oxidation resistance can be simultaneously improved. The removable insert also allows for replacement if excess wear occurs.

In one embodiment, CARBENIX® 4000 carbon-carbon composite is treated with P-13K, P-39 or other high performance phosphoric acid based anti-oxidant solutions that are known in the art. The materials are then cured by a standard process. The inserts can then be tack bonded into a mating surface in the stator. Preferably the carbon-carbon composite insert is vacuum pressure impregnated with antioxidant solution.

Oxidation treatments. Methods of treating carbon-carbon composites with an antioxidant are known in the art. One such method is to impregnate the carbon-carbon composite with an aqueous solution comprising standard antioxidants. The antioxidant solution may be administered to the carbon-carbon composite by, for example, painting the solution onto the surface of the carbon-carbon composite. The carbon-carbon composites may also be sprayed or soaked with antioxidant solution. The carbon-carbon composite is then heated to high temperature under nitrogen. The antioxidant solution can also be heated before being applied to the carbon-carbon composite.

Any antioxidants that can be used to inhibit oxidation in carbon-carbon composites, that are generally known to those of skill in the art can be used with this invention. Antioxidants that can be used with this invention include phosphate coatings of Al, Zn, or Mn, that is brushed on the edges of the brake discs and then charred. Another class of anti-oxidant treatments for carbon and graphite materials, including carbon-carbon composites, is based on using compounds that form a stable complex with active sites on the carbon composite in order to prevent oxidation.

Halogen and organohalogen compounds have been used as oxidation inhibitors at temperatures of up to 900° C. A concentrated aqueous solution of H₃PO₄ ZnO, Al(OH)₃, CuSO₄ and Cu(NO₃)₂ can also be used to inhibit oxidation at high temperatures. Similar antioxidants are described in U.S. Pat. No. 4,837,073 to McAllister et al., which is incorporated herein by reference in its entirety.

A further class of antioxidants that are especially preferred include phosphoric acid penetrants, which are coated on the carbon/carbon material. These antioxidants significantly improve the oxidative resistance of the carbon-carbon composite at the high end of the typical operating temperature range. These antioxidants are also effective in the presence of high concentrations of known oxidation catalysts, such as potassium acetate, a common constituent in aircraft runway deicers.

Such a phosphoric acid-based penetrant salt solution may contain the ions formed from one or more of the following: 10-80 wt % H₂O, 20-70 wt % H₃PO₄, 0-25 wt % MnHPO₄.1.6H₂O, 0-30 wt % Al(H₂PO₄)₃, 0-2 wt % B₂O₃, 0-10 wt % Zn₃ (PO₄)₂ and 0.1-25 wt % alkali metal mono-, di-, or tri-basic phosphate. Antioxidants suitable for use with this invention are described in U.S. Pat. No. 6,455,159 to Walker et al., which is incorporated herein by reference in its entirety.

U.S. Pat. No. 5,759,622 and U.S. Pat. No. 6,551,709 both to Stover discuss methods and materials for treating carbon-carbon composites with antioxidant. U.S. Pat. No. 2,685,539 to Woodburn et al.; U.S. Pat. No. 4,439,491 to Wilson et al.; and U.S. Pat. No. 4,837,073 to McAllister et al. also discuss methods and materials for treating carbon materials with antioxidant solutions. Each of U.S. Pat. No. 6,551,709 to Stover; U.S. Pat. No. 5,759,622 to Stover; U.S. Pat. No. 2,685,539 to Woodburn et al.; U.S. Pat. No. 4,439,491 Wilson et al.; and U.S. Pat. No. 4,837,073 to McAllister et al. are each herein incorporated by reference in their entireties.

Vacuum impregnation. The articles may be impregnated with antioxidant using any vacuum impregnation technique that is known in the art. Generally, vacuum impregnation involves first placing the article under a vacuum, then applying antioxidant to the surface of the article. Pressure is then re-applied, which forces the antioxidant into the pores of the article. Excess antioxidant is then wiped from the surface of the article.

Vacuum impregnation results in the pores of the article becoming filled with antioxidant, but does not necessarily result in a change in the size or shape of the article. Other methods of applying antioxidant to an article generally affect the surface of the article, and adversely affect the friction properties.

In one embodiment of the present invention, the carbon-carbon composites are placed into a vacuum chamber. The air is evacuated, opening fine paths within the carbon-carbon composite, which makes the pores receptive to filling with antioxidant. The antioxidant is then introduced onto the surface of the carbon-carbon composite. The chamber is then pressurized, which forces the antioxidant into the pores of the carbon-carbon composite. This is followed by rinsing to clear excess antioxidant from the external surface of the carbon-carbon composite, and removal from the chamber. The process can be done relatively quickly. Typical impregnation times are about 20-25 minutes.

The impregnation process does not alter the external surface, so carbon-carbon brake pads require no additional tooling or shaping after the process. Vacuum impregnation is effective in filling surface pores of the carbon-carbon composite as well as cracks and holes that penetrate the part.

Carbon-carbon composites. Any carbon carbon-carbon composites that are well known in the art can be used with this invention. Carbon-carbon composites are generally made of fibers, and carbonaceous polymers and/or pyrocarbon as the matrix. Carbon-carbon composites and methods of their manufacture are well known to those in the art. Carbon-carbon composites are described in Carbon-Carbon Materials and Composites, John D. Buckley and Dan D. Edie, Noyes Publications, 1993, which is incorporated herein by reference. The carbon-carbon composites of the present invention can be made with thermosetting resins as matrix precursors. These materials generally possess low densities 1.55-1.75 g/cm³ and have well-distributed microporosity. Composites made with resins as the matrix generally exhibit high flexural strength, low toughness, and low thermal conductivity.

The carbon-carbon composites of the present invention can also be made with pitch as the matrix precursor. These materials, after densification, can exhibit densities in the range of 1.8-2.0 g/cm³ with some mesopores. The carbon-carbon composites of the present invention can also be made by chemical vapor deposition (CVD). This technique uses hydrocarbon gases, and the carbon-carbon composites that are produced possess intermediate densities, and have matrices with close porosities. Composites with pitch as the precursor, and the CVD-based composites, can be made with very high thermal conductivity (400-700 W/MK) in the fiber direction.

In one preferred embodiment, the carbon-carbon composites of the present invention are prepared from carbon preforms. Carbon preforms are made of carbon fibers, which can be formed from pre-oxidized polyacrylonitrile (PAN) fibers. The carbon fibers can be layered together to form a shape, such as a friction brake pad. The shape is heated and infiltrated with methane, or another pyrolyzable carbon source, to form the carbon-carbon composite. A carbon-carbon composite prepared in this manner is preferred, and will have a density in the range of about 1.6 g/cm³ to about 1.9 g/cm³. More highly preferred is a carbon-carbon composite with a density of approximately 1.75 g/cm³.

One highly preferred carbon-carbon composite is CARBENIX™ 4000. This carbon/carbon composite material is manufactured by Honeywell International, Inc. as an aircraft brake carbon/carbon composite friction material. CARBENIX™ 4000 is made of non-woven polyacrylonitrile precursor carbon fibers, densified with carbon utilizing chemical vapor deposition.

Another highly preferred carbon-carbon composite is CARBENIX™ 2400, also manufactured by Honeywell International, Inc. CARBENIX™ 2400 is an aircraft brake carbon/carbon composite friction material, consisting of pitch precursor carbon fibers, densified with carbonized phenolic resin and with carbon from chemical vapor deposition.

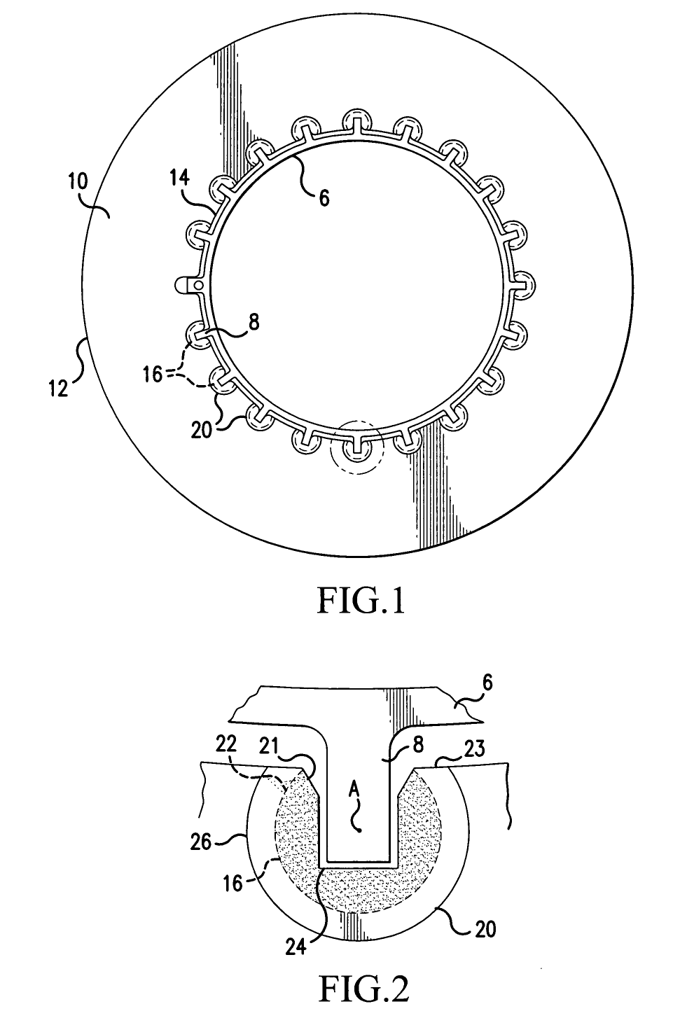

Preferred embodiments. FIG. 1 illustrates an aircraft carbon-carbon composite brake disc in accordance with this invention. The brake disc 10 is generally annular in shape and includes an outer diameter circumference 12 and a central annular opening 14. Located around the periphery of opening 14 is a plurality of slot openings or recesses for receiving brake disc annular drive inserts 20.

The Recesses 16 of disc 10 are generally annular shaped slots extending radially outwardly from opening 14 of disc 10. Annular drive inserts 20 couple a torque tube 6 with disc 10. The torque tube is coupled with the axle of an aircraft (not shown).

FIG. 2 illustrates torque tube 6 with radially extending short splines 8 which extend into openings 21 of the annular drive inserts 20. Each annular drive insert 20 comprises a generally cylindrical body 22 which rotatably engages the surface of recess 16. Body 22 is truncated at side 23 and provides opening 21 which extends diametrically into cylindrical body 22. Generally, the insert-to-stator interface may be cylindrical but is not necessarily cylindrical, for example rectangular or oval interfaces can be used. Each Body 22 comprises a removable carbon-carbon composite insert that is treated with antioxidant. Opening 21 extends past the center of revolution A of body 22 and terminates in flat surface 24 (which can have alternatively a nonflat shape) located between the center of revolution A and the outer surface of cylindrical body 22. At opposite axial ends of cylindrical body 22 are radially extending flanges 26 which engage opposite sides of disc 10 to retain axially drive insert 20 within annular slot 16

The preferred embodiments given above and shown in the Figures are examples of the invention, and are not intended to define the full scope of the invention. One skilled in the art would recognize many variations that would also be encompassed by the claims.

We claim:

1. A brake disc generally annular in shape comprising:
an outer diameter circumference and a central annular opening;
wherein located around the periphery of the central annular opening is a plurality of slot openings or recesses for receiving brake disc annular drive inserts that have been treated with an antioxidant; and
annular drive inserts that are coupled with a torque tube with the brake disc.

2. The brake disc of claim 1, wherein the brake disc comprises a carbon/carbon composite.

3. The brake disc of claim 1, wherein the annular drive inserts comprise a carbon-carbon composite.

4. The brake disc of claim 1, wherein the antioxidant comprises phosphoric acid.

5. The brake disc of claim 1, wherein the antioxidant comprises H₃PO₄ ZnO, Al(OH)₃, CuSO₄ or Cu(NO₃)₂ or a mixture thereof.

6. The brake disc of claim 1, wherein the antioxidant comprises a phosphoric acid-based salt solution which contains ions formed from one or more of the following components:
10-80 wt % H₂O;
20-70 wt % H₃PO₄;
0-25 wt % MnHPO₄.1.6H₂O;
0-30 wt % Al(H₂PO₄)₃;
0-2 wt % B₂O₃, 0-10 wt % Zn₃ (PO₄)₂; and
0.1-25 wt % alkali metal mono-, di-, or tri-basic phosphate.

7. The brake disc of claim 3, wherein the carbon/carbon composite is made from non-woven polyacrylonitrile precursor carbon fibers, densified with carbon utilizing chemical vapor deposition.

8. The brake disc of claim 3, wherein the annular drive inserts are treated by vacuum pressure impregnation with an antioxidant.

9. The brake disc of claim 8, wherein the antioxidant comprises phosphoric acid.

10. The brake disc of claim 1, wherein the annular drive inserts are treated by vacuum pressure impregnation with an antioxidant.

11. The brake disc of claim 10, wherein the antioxidant comprises H₃PO₄ ZnO, Al(OH)₃, CuSO₄ or Cu(NO₃)₂ or a mixture thereof.

12. The brake disc of claim 10, wherein the antioxidant comprises a phosphoric acid-based salt solution which contains ions formed from one or more of the following components:
10-80 wt % H₂O;
20-70 wt % H₃PO₄;
0-25 wt % MnHPO₄.1.6H₂O;
0-30 wt % Al(H₂PO₄)₃;
0-2 wt % B₂O₃, 0-10 wt % Zn₃ (PO₄)₂; and
0.1-25 wt % alkali metal mono-, di-, or tri-basic phosphate.

13. A method of protecting an annular drive insert for a brake disc comprising:
treating the annular drive insert with an antioxidant.

14. The method of claim 13, wherein the annular drive insert comprises a carbon/carbon composite.

15. The method of claim 13, wherein the antioxidant comprises phosphoric acid.

16. The method of claim 13, wherein the treatment is done by vacuum pressure impregnation.

17. The method of claim 14, wherein the treatment is done by vacuum pressure impregnation with an antioxidant.

18. The method of claim 17, wherein the antioxidant comprises phosphoric acid.
